(19) United States
(12) Patent Application Publication
(10) Pub. No.: US 2018/0262897 A1
(43) Pub. Date: Sep. 13, 2018

(54) Systems, Methods, and Devices for Emergency Services

(71) Applicant: 911 Live Connect, Mission Viejo, CA (US)

(72) Inventors: Michael Hennessy, San Clemente, CA (US); Luke Blackamore, San Clemente, CA (US)

(21) Appl. No.: 15/911,072

(22) Filed: Mar. 3, 2018

Related U.S. Application Data
(60) Provisional application No. 62/470,510, filed on Mar. 13, 2017.
(60) Provisional application No. 62/555,576, filed on Sep. 7, 2017.

(51) Int. Cl. H04W 4/90; H04M 3/51; H04W 64/00; H04W 8/20; H04M 1/725

(52) U.S. Cl. CPC H04W 4/90; H04M 3/5116; H04W 76/50; H04W 8/20; H04M 1/72538; H04W 64/006

(57) ABSTRACT

Systems, methods, and devices for providing emergency services in accordance with various embodiments of the present disclosure are provided. In one embodiment, a method for providing emergency services using an emergency telecommunications server having a processor and a network interface in network communication with a mobile device associated with a user and at least one emergency call center, the method comprising: receiving user data, at the emergency telecommunications server, from the mobile device, using the network interface; receiving location data, at the emergency telecommunications server, from the mobile device, using the network interface; determining, a first call center from the at least one call center to provide emergency services to the user associated with the mobile device; and transmitting, by the emergency telecommunications server, to the first call center, the user data and the location data using the network interface.

### CROSS-REFERENCE TO RELATED APPLICATION

This application claims priority to provisional applications Ser. Nos. 62/470,510, filed on Mar. 13, 2017 and 62/555,576, filed on Sep. 7, 2017, the entire contents of which are hereby incorporated by reference.

### FIELD OF THE INVENTION

The present disclosure generally relates to emergency services and more specifically to systems and methods for improving telecommunications to emergency service call centers using mobile devices.

### BACKGROUND

When a person calls emergency services (e.g., 911) they are routed to an emergency services call center and put in contact with an emergency services call center operator. An emergency services call center operator may then gather information from the person via a series of well-rehearsed questions. Such information may include (but is not limited to) the identity of the caller, the location of the caller, and the nature of the emergency that prompted the call. The emergency services call center operator may then utilize the gathered information to generate an emergency services dispatch request to an appropriate emergency services provider. Emergency services dispatch requests typically have standard electronic formats and are submitted with the gathered information directly to the emergency service providers. Emergency service providers may include for example police departments, fire departments, and ambulance providers.

As mobile phones (may also be referred to as “cellular phones,” “cell phones,” or “smart phones”) become more ubiquitous, more and more 911 calls are being made using mobile phones. While landlines are typically associated with an address at which the landline phone is located, cellular phones may be utilized away from whatever address maybe associated with the cellular phone. When a person calls 911 from a cell phone, the call is routed to a cell tower. However, the routed cell tower may not be the closest cell tower to the person. Upon routing to a cell tower, the call is then routed to the closest emergency call center to the cell tower. The emergency call center may then issue a request to the wireless network for location information on the calling cell phone. Such location information provided by the wireless network is often inaccurate or unavailable because many wireless networks do not have direct access to a phone's location data such as (but not limited to) GPS data. However, such location information is essential in order to generate a dispatch order to emergency services. Even further, 911 callers often cannot correctly identify their location verbally due to distress or confusion.

### SUMMARY OF THE INVENTION

The various embodiments of the present emergency services telecommunication systems contain several features, no single one of which is solely responsible for their desirable attributes. Without limiting the scope of the present embodiments, their more prominent features will now be discussed below. In particular, the present emergency services telecommunication systems will be discussed in the context of calls made to emergency call centers. However, the use of specific call protocols (e.g., dialing 911) is merely exemplary and various other protocols and/or device configurations may be utilized as appropriate to the requirements of a specific application in accordance with various embodiments of the invention. After considering this discussion, and particularly after reading the section entitled “Detailed Description,” one will understand how the features of the present embodiments provide the advantages described here.

One aspect of the present embodiments includes the realization that emergency call centers lack access to data that consumers would otherwise expect to be shared when utilizing a mobile device. For instance, consumers would expect that their current location data would be shared with 911 operators upon calling with a mobile phone. However, cellular networks often simply do not transmit any location information and typically rely on rough triangulation between cell towers. The present embodiments solve this problem by introducing servers, applications, and communication channels that may transmit emergency related information from mobile devices to call center operators in circumvention of the limitations of cellular networks. The present embodiments thus advantageously enable more rapid and accurate interactions with emergency call center operators. The present embodiments provide these advantages and enhancements, as described below.

In a first aspect, a method for providing emergency services using an emergency telecommunications server having a processor and a network interface in network communication with a mobile device associated with a user and at least one emergency call center is provided, the method comprising: receiving user data, at the emergency telecommunications server, from the mobile device, using the network interface; receiving location data, at the emergency telecommunications server, from the mobile device, using the network interface; determining, a first call center from the at least one call center to provide emergency services to the user associated with the mobile device; and transmitting, by the emergency telecommunications server, to the first call center, the user data and the location data using the network interface.

In an embodiment of the first aspect, the method further comprise receiving emergency data, at the emergency telecommunications server, from the mobile device, using the network interface; and transmitting, by the emergency telecommunications server, to the first call center, the emergency data using the network interface.

In another embodiment of the first aspect, the user data includes a user name.

In another embodiment of the first aspect, the user data includes a date of birth.

In another embodiment of the first aspect, the user data includes a call back number.

In another embodiment of the first aspect, the user data includes medical history data.

In another embodiment of the first aspect, the user data includes drug allergies data.

In another embodiment of the first aspect, the user data includes health data captured using the mobile device.

In another embodiment of the first aspect, the emergency data includes an emergency type provided by the user using the mobile device.

In another embodiment of the first aspect, the emergency data includes image data captured using a camera of the mobile device.

In another embodiment of the first aspect, the location data includes a longitude coordinate and a latitude coordinate of the mobile device.

In another embodiment of the first aspect, the longitude and latitude coordinates are derived using global positioning system (GPS) data.

In another embodiment of the first aspect, the longitude and latitude coordinates are derived using Wi-Fi data.

In another embodiment of the first aspect, the longitude and latitude coordinates are derived using IP Address data.

In another embodiment of the first aspect, the longitude and latitude coordinates are derived using cell tower triangulation data.

In another embodiment of the first aspect, the longitude and latitude coordinates are derived using metadata collected by the mobile device.

In another embodiment of the first aspect, the method further comprises receiving, at the emergency telecommunications server, from the first call center, a request for additional data using the network interface.

In another embodiment of the first aspect, the method further comprises determining the first call center using the user data.

In another embodiment of the first aspect, the method further comprises determining the first call center using the location data.

In another embodiment of the first aspect, the method further comprises determining the first call center using the emergency data.

In many embodiments an emergency services telecommunication system may include at least one mobile device and at least one emergency telecommunications server. In various embodiments, the mobile device may provide an interface and components by which emergency related information may be gathered. This emergency related information may include a variety of data including (but not limited to) user identification data, emergency type data, and location data. In several embodiments, the data may be transmitted along with a request to call an emergency hotline to the emergency telecommunications server. In many embodiments, the emergency telecommunications server may store and utilize the transmitted data to select the most appropriate emergency call center. The emergency call may then be completed between the mobile device and the call center with the emergency telecommunications server providing access to the emergency related information via a content management system link. Emergency services telecommunication systems in accordance with embodiments of the invention are further described below.

### BRIEF DESCRIPTION OF THE DRAWINGS

The various embodiments of the present invention now will be discussed in detail with an emphasis on highlighting the advantageous features. These embodiments depict the novel and non-obvious embodiments shown in the accompanying drawings, which are for illustrative purposes only. These drawings include the following figures:

FIG. 1 is a network architecture diagram illustrating a system for emergency services telecommunications in accordance with an embodiment of the invention;

FIG. 2 is a block diagram illustrating a mobile device in accordance with an embodiment of the invention;

FIG. 3 is a block diagram illustrating an emergency call center console in accordance with an embodiment of the invention;

FIG. 4 is a block diagram illustrating an emergency services telecommunications server in accordance with an embodiment of the invention;

FIG. 5 is a schematic illustration of an emergency services telecommunication system in accordance with an embodiment of the invention;

FIG. 6 is a conceptual illustration of a mobile device with a graphical user interface in accordance with an embodiment of the invention;

FIG. 7 is a flow chart illustrating a process for managing contacts to emergency services using an emergency services telecommunications server in accordance with an embodiment of the invention; and

FIG. 8 is a flow chart illustrating a process for contacting emergency services using a mobile device in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features. These drawings, and their written descriptions, indicate that certain components of the apparatus are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, as used herein the term integral describes a single unitary piece.

Turning now to the drawings, systems and methods for emergency services telecommunication systems that provide emergency call centers with critical data gathered from mobile devices including (but not limited to) user data, caller location data, and caller emergency data are provided. In many embodiments, emergency services telecommunication systems may include several components that work to improve the quality and promptness of emergency service dispatch generation. In various embodiments, emergency services telecommunication systems may include collecting various data such as (but not limited to) user data, caller location data, current mobile device GPS location data, a universal unique phone identifier (UUID), and caller-inputted emergency data from a mobile device used to call an emergency service. In some embodiments, the mobile device may include an application interface for collecting user data prior to calling and/or being connected with emergency services. Such user data may include (but is not limited to) name, address, phone number, email address, emergency contact name, emergency contact phone number, and/or emergency contact address.

Many embodiments may provide an application interface for determining and reporting a type of emergency associated with an emergency services call. Such types of emergency may include (but are not limited to) fires, medical emergencies, robberies and violence, car accidents, drunk drivers, firearm discharges, and/or general emergency assistance. Yet further embodiments may provide for a graphical user interface by which emergency data may be rapidly generated according to the nature of an emergency.

Some embodiments may also provide for an application interface by which location data associated with the caller and/or mobile device may be generated. Other embodiments may also automatically generate location data utilizing hardware and/or software functionalities of the mobile device. Several embodiments further provide for interfaces by which a user may adjust or input the location data if the location of the emergency is different than that of the location of the mobile device. Once user, emergency, and location data are gathered and/or generated at the mobile device, some embodiments further provide for interfaces to enable the sending of the data to an emergency call center in conjunction and/or in addition to a call to emergency call center.

Yet further embodiments may provide for interfaces by which the user, emergency, and/or location data may be pre-programmed and stored in databases for rapid utilization during an emergency services call. Emergency services telecommunication systems in accordance with embodiments of the invention may further include databases that store collected data including (but not limited to) user data, emergency data, and/or location data. The pre-programming of this information utilizing embodiments of the invention ensures swift and accurate response to an emergency when time is of the essence and stress levels may be high. The stored data may be utilized in conjunction with web services provided by emergency services telecommunication systems in accordance with embodiments of the invention.

In various embodiments, web services may include a content management system (CMS) (may also be called herein as “911 Live Connect CMS”) that may communicate the stored and/or collected user data, emergency data, and/or location data to 911 dispatch centers. Even further, the CMS may be utilized to provide continuous access to databases of previously stored emergency call data. The CMS may transmit this stored information on request to emergency call centers. In addition, some embodiments may provide for optimized selecting and routing of calls to the most appropriate of available emergency call centers. Such optimizations may be achieved utilizing computational techniques of some embodiments that determine precise GPS latitude and longitude values of the emergency. Such precise GPS latitude and longitude values may then be utilized to map latitude and longitude boundaries for each emergency call center. The latitude and longitude values may then be queried against the maps of emergency call center according to particular search parameters. For instance, some embodiments may utilize search parameters that limit the query to emergency call centers whose service boundaries overlapped the determined latitude and longitude values of the emergency.

In still further embodiments, content management systems (CMS) may include application interfaces located at emergency call centers that allow access to stored user data, emergency data, and/or location data. Such application interfaces may enable automatic and near-instantaneous display of emergencies reported by the emergency services telecommunication system. In some embodiments, the display may be limited to reports of emergency within the service boundaries of respective emergency call centers. In various embodiments, display of the emergencies may be sorted by emergency type and location to facilitate efficient handling of emergency reports and manage duplicate reports. Emergency services telecommunication systems in accordance with embodiments of the invention are further discussed below.

### Emergency Services Telecommunication Systems

Emergency phone services (such as 911 in the United States) rely on rapid and reliable telecommunications between callers in distress and emergency call center operators. Emergency phone services were initially designed with landlines in mind, where each landline would have a registered address. Although mobile devices and cellular phones have enabled people to more effectively make calls from the site of emergencies, the underlying infrastructure of the wireless networks was never designed to accurately relay location, emergency, or identification data. Embodiments of the invention provide for emergency services telecommunication systems that overcome these challenges and facilitate rapid transmission of critical information to emergency call centers.

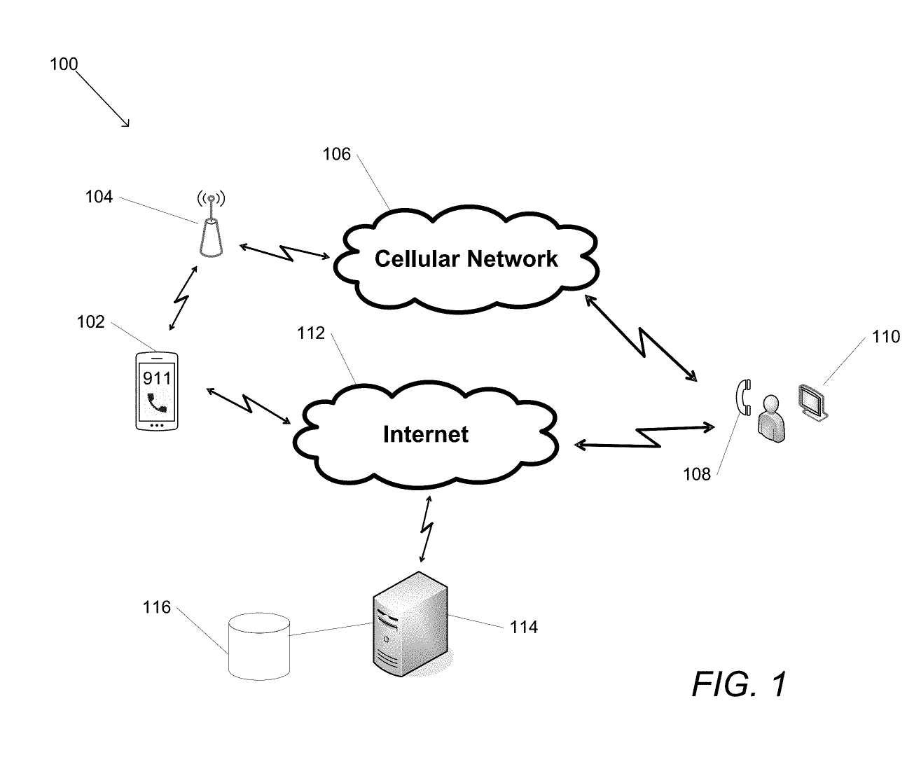

Emergency services telecommunication systems in accordance with embodiments of the invention may incorporate several types of electronic devices. Servers, web applications, virtual machines, communication networks, mobiles devices, and/or call center equipment may be included in an illustration of an embodiment of the invention shown in FIG. 1. Emergency services telecommunication system 100 may include several components such as (but not limited to) application servers, database servers, internet communication links, cellular communication links, mobile devices, and/or computing devices. Embodiments of the invention may utilize subsets of these components and omit some components without departing from the spirit of the invention. While the emergency services telecommunication system 100 is shown including exemplary devices, a person skilled in the art will recognize that the invention is not limited to the devices shown in FIG. 1 and may include additional types of electronic devices. For instance, tablets, VOIP phones, legacy cellular phones, smart phones, virtual servers, and/or cloud based serving may be utilized in different embodiments of the invention. Different architectures involving electronic devices and network communications may be utilized to implement emergency services telecommunication systems without departing from the spirit of the invention.

In reference to FIG. 1, mobile device 102 is an electronic device (e.g., cellular phone, laptop computer, smart phone, and/or tablet computer) that may make calls to emergency services call centers. As used herein, a “call” may also include other forms of contacting emergency services call centers. For example, a user may contact an emergency services call center by clicking a button or selecting a button on a screen of an electronic device. As shown, a dial icon is shown with the numbers ‘911’ to indicate that mobile device 102 may make an emergency service call to the standard emergency line in the United States. Other emergency service call numbers may be made without departing from the spirit of the invention. In various embodiments, the mobile device 102 may provide geographic location information via Global Position System (GPS) hardware (e.g., a GPS receiver and/or a GPS antenna). However, cellular networks often simply don't transmit any location information or simply rely on rough triangulation between cell towers. Even further, emergency service call centers typically have no means to access data networks that are connected to such mobile devices. This may come as a surprise to consumers who are used to mobile device applications sharing precise location information over data and/or internet networks (e.g., 4G LTE).

In various embodiments, the mobile device 102 may reach an emergency service call center across a telecommunications pathway including cellular tower 104 and cellular network 106. In many embodiments, the cellular tower 104 may also be a wireless network tower or any other mobile phone service providing infrastructure. Cellular network 106 may include many transmitters, radios, and/or antennas as necessary to pass voice communications between endpoints such as the mobile device 102 and emergency call center phone 108. Once such a voice communication link is established, a user of mobile device 102 may communicate with an operator interacting with emergency call center phone 108 and/or emergency call center console 110. In various embodiments, the emergency call center console 110 does not directly receive data (i.e., non-voice data) from the mobile device 102.

In order to facilitate transmission of data to emergency call centers, emergency services telecommunication system 100 may further include an emergency services telecommunications server 114 and an emergency services telecommunications database 116 that may communicate with the mobile device 102 and/or the emergency call center console 110 via the Internet 112. Other embodiments may use other networks, such as Ethernet or virtual networks, to communicate between devices. A person skilled in the art will recognize that the invention is not limited to the network types shown in FIG. 1 and may include additional types of networks (e.g., intranets, virtual networks, mobile networks, and/or other networks appropriate to the requirements of specific applications).

As shown, the mobile device 102 may transmit user identification data, location data, and emergency data to the emergency telecommunications server 114 which may be stored in emergency services telecommunications database 116. In many embodiments, transmitting emergency data to telecommunications server 114 may supplement calls to emergency call centers using data passed through content management systems (CMS), as further described below. In various embodiments, CMS may be part of and/or run on an emergency telecommunications server 114, as further described below. In some embodiments, transmitting emergency data to the emergency telecommunications server 114 may include transmitting emergency call data through a CMS directly to an emergency call center console to facilitate rapid response to emergency calls. Further, the emergency data transmitted to the emergency telecommunications servers may optimize selection of emergency call centers through analysis of location data transmitted by the mobile device(s) 102.

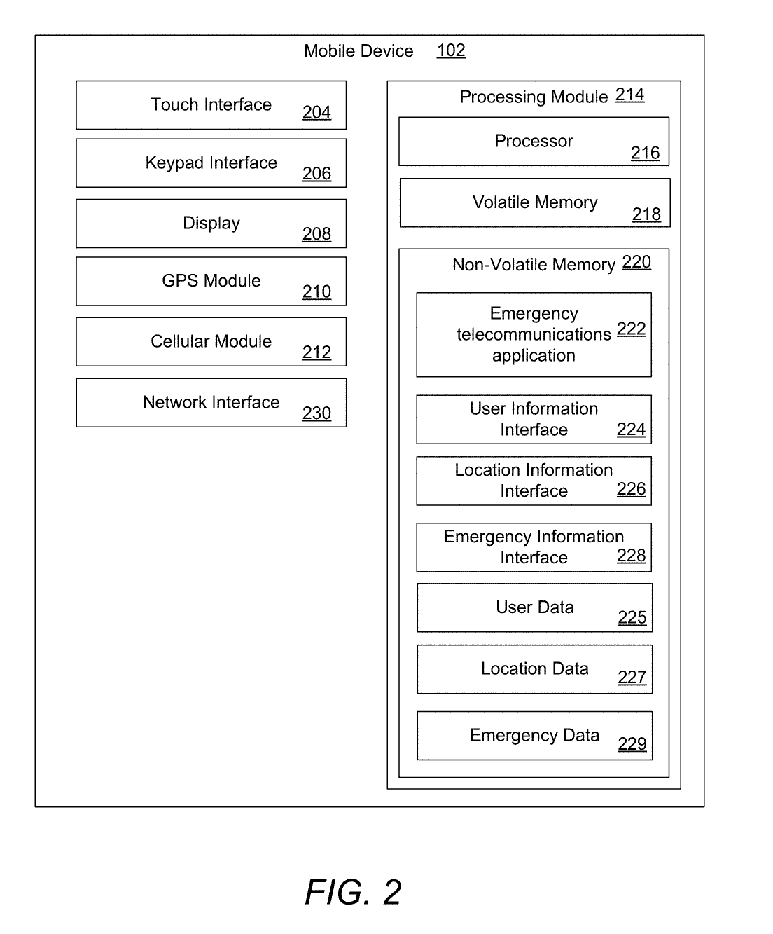

Block diagrams of specific hardware configurations for mobile devices, emergency call center consoles, and emergency telecommunications servers in accordance with particular embodiments of the invention are illustrated in FIG. 2-4, respectively. These exemplary embodiments may be utilized in part of a larger emergency services telecommunication system. While particular combinations of subcomponents are illustrated, other combinations are possible without departing from the spirit of the invention.

A block diagram illustrating a mobile device 102 in accordance with an embodiment of the invention is shown in FIG. 2. Mobile device 102 of FIG. 2 may serve as a mobile device in the emergency services telecommunication system of FIG. 1. The mobile device 102 may include a touch interface 204 and/or a keypad interface 206, a display 208, a GPS module 210, a cellular module 212, and network interface 230. Further, the mobile device 102 may also include a processing module 214 comprising a processor 216, a volatile memory 218, a non-volatile memory 220, where the non-volatile memory 220 may further comprise an emergency telecommunications application 222, a user information interface 224, a location information interface 226, and an emergency information interface 228. The touch interface 204 and/or keypad interface 206 may provide means by which a user may interact with the mobile device 102. In various embodiments, the display 208 may show various views, screens, and graphics to support emergency services telecommunication systems. GPS module 210 may provide location information utilizing GPS coordinates and data. Other embodiments may utilize other means of determining location information without departing from the spirit of the invention. Cellular module 212 provides for a cellular connection to cellular phone networks. Network interface 230 may provide for a communication link to data networks such as (but not limited to) 4G, Bluetooth, and/or WiFi.

In many embodiments, the processing module 214 includes several sub-components that together provide for telecommunications functionality. Processor 216 may be any generic processing unit capable of performing computations to support mobile device functionality. Volatile memory 218 may be Randomly Accessed Memory (RAM) or another comparable form of rapid storage. Non-volatile memory 220 may be any memory type that retains storage of data after shutting down of the mobile device 102. In various embodiments, the non-volatile memory 220 stores several applications and interfaces. For example, the emergency telecommunications application 222, when executed by processor 216, may provide for interfaces, uploads, downloads, and data functionality necessary to support emergency services telecommunication systems. Further, the emergency telecommunications application 222 may link to interfaces and views provided by user information interface 224, location information interface 226, and emergency information interface 228. In some embodiments, the user information interface 224 may receive user identity information (i.e., user data 225). In various embodiments, the user data 225 may include various user related information such as (but not limited to) user name, date of birth, call back number, medical history data, and/or medical health data. In some embodiments, the user data 225 may include various health data captured using the mobile device 102 such as (but not limited to) activity data, nutrition data, sleep data, heart data (e.g., blood pressure and/or heart rate), reproductive health, body temperature, respiratory rate, body measurements, etc. In some embodiments, the location information interface 226 may provide maps and other tools to assist a user in pinpointing the location of an emergency. In various embodiments, the mobile device 102 may store location data 227 that may include longitude and/or latitude coordinates of the mobile device. In some embodiments, the longitude and/or latitude coordinates may be derived using global positioning system (GPS) data, Wi-Fi data, IP address data, and/or cell tower triangulation data. In some embodiments, the longitude and/or latitude coordinates may be derived using metadata collected by the mobile device. In some embodiments, the emergency information interface 228 may provide options for identifying a type of emergency where the identified type of emergency may be transmitted to the emergency call center. For example, the type of emergency may be stored as emergency data 229 in the non-volatile memory 220, as further described below. In some embodiments, the mobile device 102 may include one or more cameras, where the emergency data 229 may include image data captured using the camera of the mobile device.

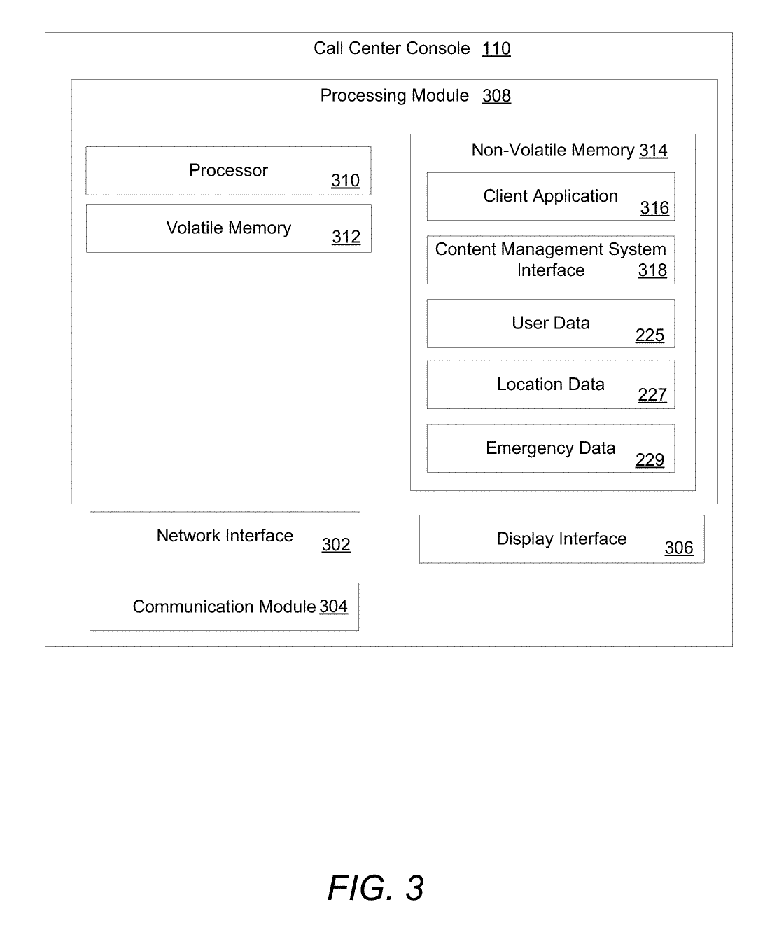

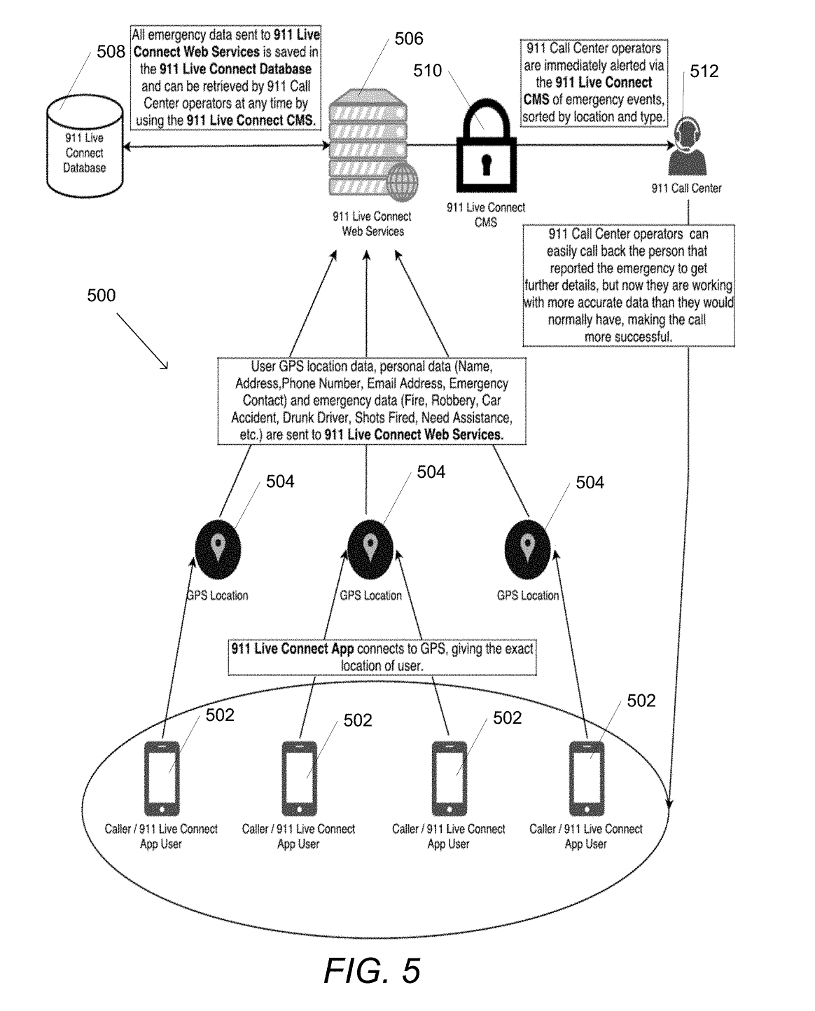

A block diagram illustrating a call center console 110 in accordance with an embodiment of the invention is shown in FIG. 3. In many embodiments, the call center console 110 of FIG. 3 may serve as a call center console in the emergency services telecommunication system shown in FIG. 1 and/or the 911 call center 512 shown in FIG. 5. In some embodiments, the call center console may be any computing device such as (but not limited to) a server and/or a computer.

In reference to FIG. 3, call center console 110 may include a network interface 302, a communication module 304, and a display interface 306. Further, the call center console 110 may include a processing module 308 comprising a processor 310, a volatile memory 312, and a non-volatile memory 314. In various embodiments, the non-volatile memory 314 may store a client application 316 and a content management system interface 318. In many embodiments, the call center console 110 may receive user data 225, location data 227, and/or emergency data 229 from an emergency telecommunications server 114, as further described below. In addition, a content management system (may also be referred to as “CMS”) may be stored on an emergency telecommunications server (may also be referred to herein as a “911 Live Connect server”) that may be accessible to a 911 call center console 110 via a secure web interface such as (but not limited to) the content management system interface 318. In various embodiments, the network interface 302 provides for a communication link to data networks such as (but not limited to) LAN, CATS, Internet, 4G, Bluetooth, and/or WiFi. In many embodiments, the communication module 304 may interface with connected phones, audio devices, and/or radios to enable communication with callers, emergency service providers, and/or other individuals. In some embodiments, the display interface 306 may link to an electronic display. In many embodiments, the processing module 308 may include several sub-components that together provide for emergency services response functionality. For example, the processor 310 may be any generic processing unit configured to perform computations to support call center console functionality. As described herein, the volatile memory 312 may be Randomly Accessed Memory (RAM) or another comparable form of rapid storage. Further, the non-volatile memory 314 may store several applications and interfaces. For example, the client application 316 may support graphical interfaces, data entry, and dispatch management. In addition, the content management system interface 318 may enable receipt of emergency data 229, user data 225, and/or location data 225 from emergency telecommunications management servers, as further described below.

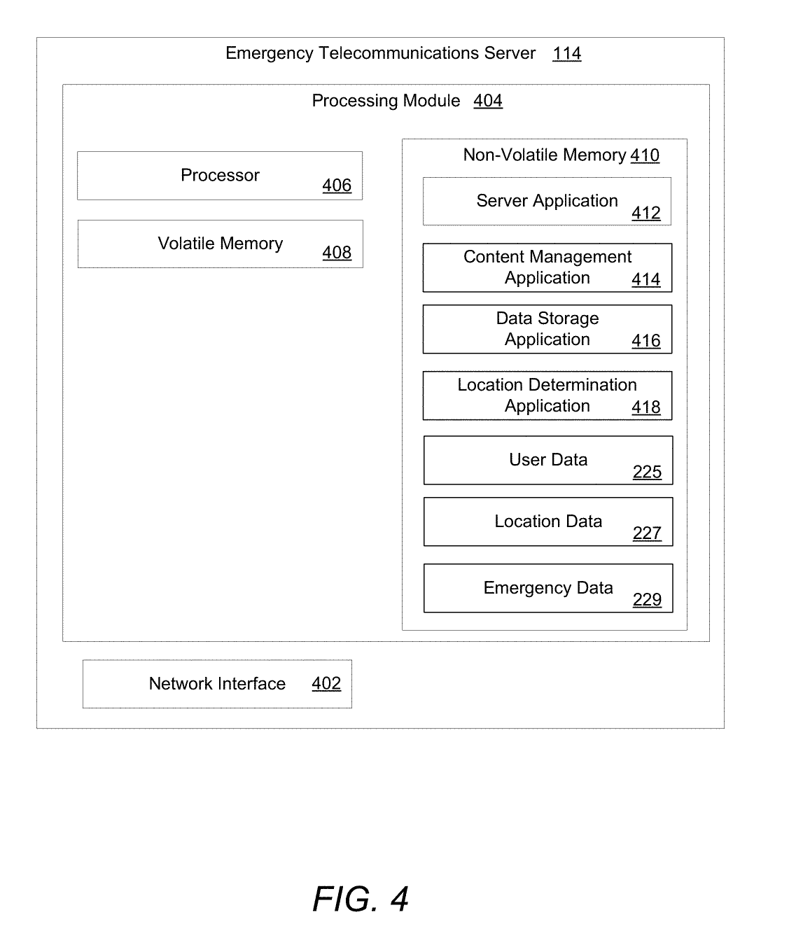

In various embodiments of the invention, emergency telecommunications servers may include a remote 911 Live Connect server running a 911 Live Connect CMS. In many embodiments, such emergency telecommunications servers are not owned or controlled by the 911 call centers. A block diagram illustrating an emergency telecommunications server 114 in accordance with an embodiment of the invention is shown in FIG. 4. In various embodiments, the emergency telecommunications server 114 of FIG. 4 may serve as an emergency telecommunications server in the emergency services telecommunication system shown in FIG. 1 and/or the 911 Live Connect Web Services 506 of FIG. 5. In many embodiments, the emergency telecommunications server 114 may include a network interface 402 and a processing module 404 comprising a processor 406, a volatile memory 408, a non-volatile memory 410, a server application 412, a content management application 414, a data storage application 416, and a location determination application 418. In some embodiments, the server application 412 may include the functionalities of the content management application 414, data storage application 416, and/or the location determination application 418. In several embodiments, the network interface 402 provides for a communication link to data networks such as (but not limited to) LAN, CATS, Internet, 4G, Bluetooth, and/or WiFi. In many embodiments, the processing module 404 includes several sub-components that together provide for emergency services response functionality. For example, the processor 406 may be any generic processing unit configured to perform computations to support call center console functionality. As described herein, the volatile memory 408 may be Randomly Accessed Memory (RAM) or another comparable form of rapid storage. Further, the non-volatile memory 410 may store several applications and interfaces. For example, the server application 412 may provide web services and networking services that enable receipt (e.g. receive from a mobile device) and distribution (e.g. transmit to a call center console) of data including (but not limited to) user data 225, emergency data 229, call data, and/or location data 229. Further, the server application 412 and/or the content management application 414 may communicate the stored and/or collected user data 225, emergency data 229, and/or location data 227 to various emergency call centers (e.g. a first call center, second call center, etc.). In addition, the server application 412 and/or the data storage application 416 may further store and retrieve data in an associated emergency services telecommunication database, as described herein. Furthermore, the server application 412 and/or the location determination application 418 may determine precise GPS latitude and longitude values (may also be referred to as “coordinates”) of a reported emergency and direct any calls to the most geographically appropriate emergency call center.

In the illustrated embodiments of FIGS. 2-4, the various components including (but not limited to) the processing modules 214, 308, 404, and the network interfaces 230, 302, 402 are represented by separate boxes. The graphical representations depicted in each of FIGS. 2-4 are, however, merely examples, and are not intended to indicate that any of the various components of the mobile device 102, the call center console 110, or the emergency telecommunications server 114 are necessarily physically separate from one another, although in some embodiments they might be. In other embodiments, however, the structure and/or functionality of any or all of the components of mobile device 102 or emergency telecommunications server 114 may be combined. Further, the structure and/or functionality of any or all of the components of the emergency telecommunications server 114 may be combined. In addition, in some embodiments network interfaces 230, 302, 402 may include their own processors, volatile memories, and/or non-volatile memories. In addition, modules, such as the communication module 304, the GPS module 210, the cellular module 212, and network interfaces 230, 302, 402 may comprise (but is not limited to) one or more transceivers and/or wireless antennas (not shown) configured to transmit and receive wireless signals such as (but not limited to) satellite, radio frequency (RF), Bluetooth or WIFI. In other embodiments, the communication module 304, the GPS module 210, the cellular module 212, and network interfaces 230, 302, 402 may comprise (but are not limited to) one or more transceivers configured to transmit and receive wired signals.

In further reference to FIGS. 2-4, in various embodiments, the communication module 304 the GPS module 210, the cellular module 212, and the network interface 414 may be configured to transmit and/or receive data detected by the various sensors within mobile device 102, as described above. Although specific systems for emergency services telecommunication systems are discussed above with respect to FIGS. 1-4, any of a variety of systems including a variety of computing devices, mobile devices, servers, and communication devices that communicate using various communication protocols as appropriate to the requirements of a specific application may be utilized in accordance with embodiments of the invention. An example emergency services telecommunication system in accordance with embodiments of the invention are discussed further below.

### An Example Emergency Services Telecommunication Systems

Emergency services telecommunication systems may automatically provide emergency call centers with critical data gathered from mobile devices. Such data is often inaccessible to call centers as cellular networks do not provide data streams. Even further, what information that may be gleaned through cell tower triangulation is often not helpful in an emergency situation. In order to improve emergency call center response times and accurate dispatches, embodiments of the invention provide for a data pathway from mobile devices to call center consoles utilizing emergency telecommunications servers. For example, an emergency telecommunications server may precisely calculate latitude and longitude values for an emergency using GPS location data that may not be directly accessed by emergency call center consoles. The emergency telecommunications server may further utilize the calculated latitude and longitude values to identify and route an emergency call to the best (i.e., closest or highest bandwidth) available emergency call center.

An exemplary emergency services telecommunication system 500 with data flows between components is conceptually illustrated in FIG. 5. As shown, mobile devices 502 may include an application (e.g. emergency telecommunications application 222) to enable connection to emergency telecommunications server 506 (may also be referred to as “Web Services” or “911 Live Connect Web Services”). In various embodiments, an application running on the mobile devices 502 may initiate a call to an emergency service call center 512. After and/or during initiation, one or more mobile device 502 may provide data such as (but not limited to) user data, emergency data, and/or location data (e.g., GPS data) to the emergency telecommunications server 506.

In various embodiments, the mobile devices 502 may provide GPS data such as (but not limited to) GPS locations 504 utilizing GPS modules within the mobile devices 502 and access to GPS satellites. In addition, mobile devices 502 may provide user data such as (but not limited to) name, address, phone number, date of birth, call back number, medical history, drug allergies, email address, and/or emergency contacts. Mobile devices 502 may further provide emergency data such as (but not limited to) indication of a fire, indication of a robbery, indication of a car accident, reporting a drunk driver, indication of shots fired, and/or indication of a general need for assistance.

In many embodiments, the emergency telecommunications server 506 may store the received information from the mobile device in a separate database 508 (may also be referred to as “911 Live Connect Database”). In some embodiments, the database 508 may be an integral part of the emergency telecommunications server 506 or separate, as illustrated. The data received and saved by the emergency telecommunications server 506 may then be retrieved by call center operators via call center consoles on request via a content management system 510 (CMS) (may also be referred to as “911 Live Connect CMS”). In various embodiments, the CMS 510 may be application (e.g. server application 412) running on the emergency telecommunications server 506. For example, the CMS 510 may be provided by the emergency telecommunications server 506 and may further provide alerts and notifications to call center operators. Dispatches of information from the emergency telecommunications server 506 along CMS 510 may include identification of emergency events (e.g. emergency data 229) that may further be sorted according to location, type, time reported, and/or severity. The CMS 510 may further facilitate rapid callback to dropped callers via stored user data 225 such as (but not limited to) identification information (such as phone numbers). In various embodiments, call center operators may use a call center console to generate and transmit notifications to a user that reported an emergency. For example, a call center operator may use the user data, location data, and/or emergency data to generate one or more custom notifications that may be pushed to a user's mobile device using push protocols known in the art. In such embodiments, the custom notification(s) may be pushed to the user's mobile device without the user's mobile device requesting the custom notifications. In many embodiments, the custom notifications may be received at the user's mobile device in the form of a pop up message. In some embodiments, the custom notification(s) may also include images and/or hypertext links to additional information. In other embodiments, the custom notifications may be generated and transmitted by the emergency telecommunications server 506 automatically without the assistance of a call center operator.

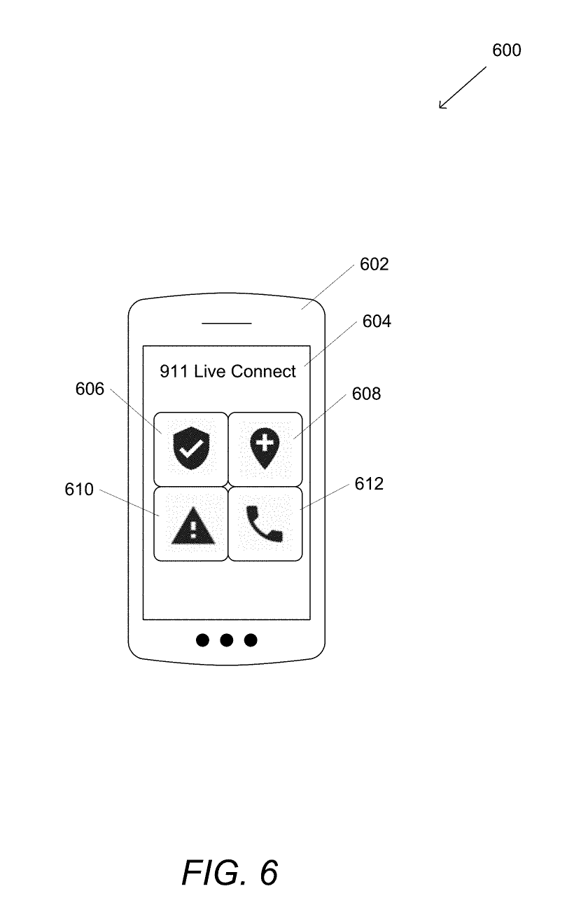

Emergency services telecommunication systems of many embodiments may utilize a mobile device application to facilitate transmission of emergency-relevant information to emergency call centers. A mobile device 600 with an emergency call application that provides a graphical user interface in accordance with an embodiment of the invention is shown in FIG. 6. In various embodiments, the mobile device 600 may be identical or similar to mobile device 102, as described above. As shown, mobile device 600 may include a phone hardware 602. In various embodiments, the mobile device 600 may include an emergency telecommunications application (e.g., emergency telecommunications application 222) that configures a processor (e.g. 216) to present an emergency call application interface 604. For example, the phone hardware 602 may include a touchscreen on which an emergency call application interface 604 is displayed. The emergency call application interface 604 may include several buttons that correspond to varying functions and views of the application. For example, a user registration button 606 may take a user to a user information registration screen where user data may be collected. Such user data may include (but is not limited to) name, address, phone number, email address, emergency contact name, emergency contact phone number, and/or emergency contact address. Further, in some embodiments, a location button 608 may take a user to a map and location menu that allows for a user to provide location data by pinpointing the location of an emergency on the map. In addition, an emergency type button 610 may take a user to an interface that allows a user to provide emergency data by selecting of an emergency type. Such emergency data may include (but are not limited to) fires, medical emergencies, robberies, car accidents, drunk drivers, firearm discharges, and/or general emergency assistance. In many embodiments, the information collected via the above menus may be transmitted and stored by an emergency telecommunications server for providing emergency services, as described above.

In several embodiments, the graphic user interface may also present a dial button 612 that initiates a call to emergency services. In many embodiments, the dial button 612 may be selected with or without the user having entered the various data as described herein. Once the dial button 612 is selected, a call may be made and communication may be initiated with an emergency telecommunications server, as described above. In various embodiments, the emergency telecommunications server may provide such information through a content management system to emergency call centers, as described above. The emergency telecommunications server may determine the most appropriate call center and route the call to that emergency call center, as described above.

In many embodiments, the emergency call application interface 604 may serve as a front end component of a larger emergency services telecommunication system. While a specific configuration of an application interface was shown in FIG. 6, this is merely one embodiment of such an application interface. Other embodiments may utilize different screens, buttons, menus, and the like without departing from the spirit of the invention. For instance, dropdowns or single page apps may also provide for the collection of user data, location data, and emergency data.

Although specific emergency services telecommunication systems are discussed above with respect to FIGS. 5 and 6, any of a variety of emergency services telecommunication systems having differing combinations of devices and various components as appropriate to the requirements of a specific application may be utilized in accordance with embodiments of the invention. For example, the various components and functionalities of the mobile device 600 may be configured to be part of an in-dash unit in a vehicle. In such embodiments, a user may interact with the in-dash unit to perform the functionalities and processes as described above with respect to mobile devices. In some embodiments, the in-dash unit may be configured to work hands free so that a user may use it while driving. In some embodiments, the in-dash unit may be a separate unit or a part of an existing unit of a vehicle. In some embodiments, the in-dash unit may include a monitor that mirrors the user interface of the mobile device 600 but may accept user input using hands free methods such as (but not limited to) voice commands of the user. In such embodiments, the mobile device 600 and the in-dash unit may be connected using various wireless protocols (or wired protocols) for exchanging data over short distances such as (but not limited to) Bluetooth®. Processes for servers and mobile devices of emergency services telecommunication systems in accordance with embodiments of the invention are discussed further below.

### Processes for Emergency Services Telecommunication Systems

Emergency services telecommunication systems may be implemented across several different types of devices. These varying devices may each perform different tasks in different embodiments. For instance, an emergency telecommunications server may receive user data, caller location data, and caller emergency data and set up calls between mobile devices and emergency call centers. Whereas a mobile device may gather and transmit user data, caller location data, and caller emergency data and initiate calls to emergency call centers.

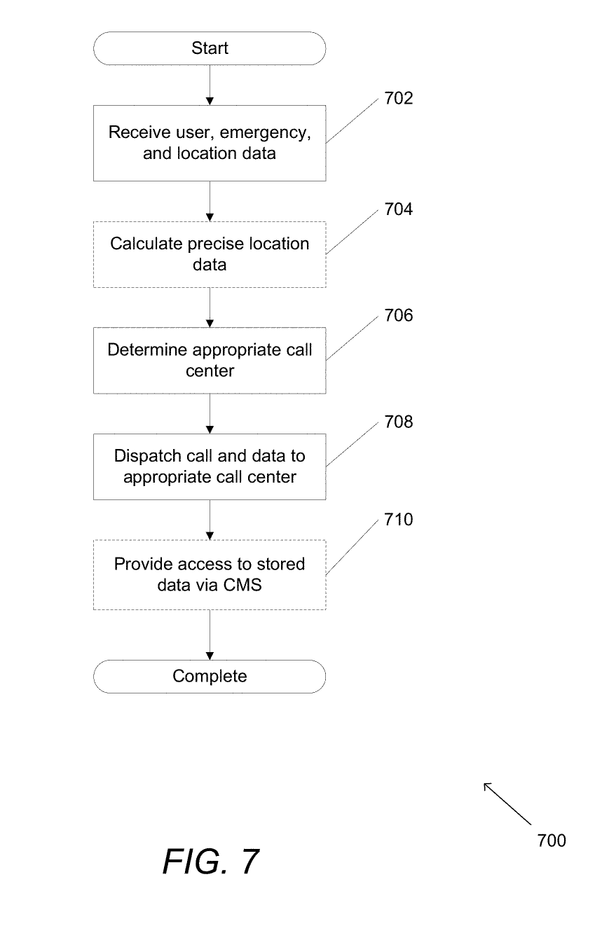

A flow chart illustrating a process for handling emergency calls utilizing an emergency services telecommunication system in accordance with an embodiment of the invention is shown in FIG. 7. As described above, a user may contact a 911 call center using a variety of methods. For example, the user may call by dialing 911, the user may click a button, or the user may touch a selection on a screen of a mobile device to initiate contact with the call center. The process 700 may be executed by a processor on a server (e.g., emergency telecommunications server 114 and/or 911 Live Connect Web Services 506) using an emergency telecommunications application (e.g. server application 412 and/or CMS 510) stored on a non-volatile memory of the server, as described above. The process 700 may receive (702) user data, caller location data, and caller emergency data, as described above. For example, user data, caller location data, and/or caller emergency data may be initially collected by a mobile device. In some embodiments, such information may be received as a part of a request to initiate an emergency call or already be stored on the mobile device.

The process 700 may calculate (704) precise location data of the mobile device. In some embodiments, the calculated precise location data may identify where an emergency is occurring with increased precision. In some embodiments, the location of the emergency may be identified via latitude and longitude coordinates, as described above. The process 700 may determine (706) an appropriate call center to handle the emergency call. For example, in various embodiments, the process 700 may include determine (706) a first call center from one or more call centers that may be selected. In some embodiments, the process 700 may further map out latitude and longitude points on a map for the boundaries of each available call center and determine the appropriate call center using the map and previously calculated precise location data.

The process 700 may then dispatch (708) a call and/or data (e.g. user data, location data, emergency data) to the appropriate call center. The process 700 may provide (710) access to gathered, calculated, and/or stored data via a content management system (CMS). In some embodiments, the CMS may provide direct access to data to consoles of emergency call center operators. Some embodiments may perform the above operations in varying orders without departure from the spirit of the invention. In addition, some embodiments only begin receipt of user, emergency, and/or location data after initiation of an emergency call on a mobile device. Other embodiments may continuously gather information from mobile devices and/or gather practical information and may supplement the information with further data gathered at the time of initiation of an emergency call on a mobile device.

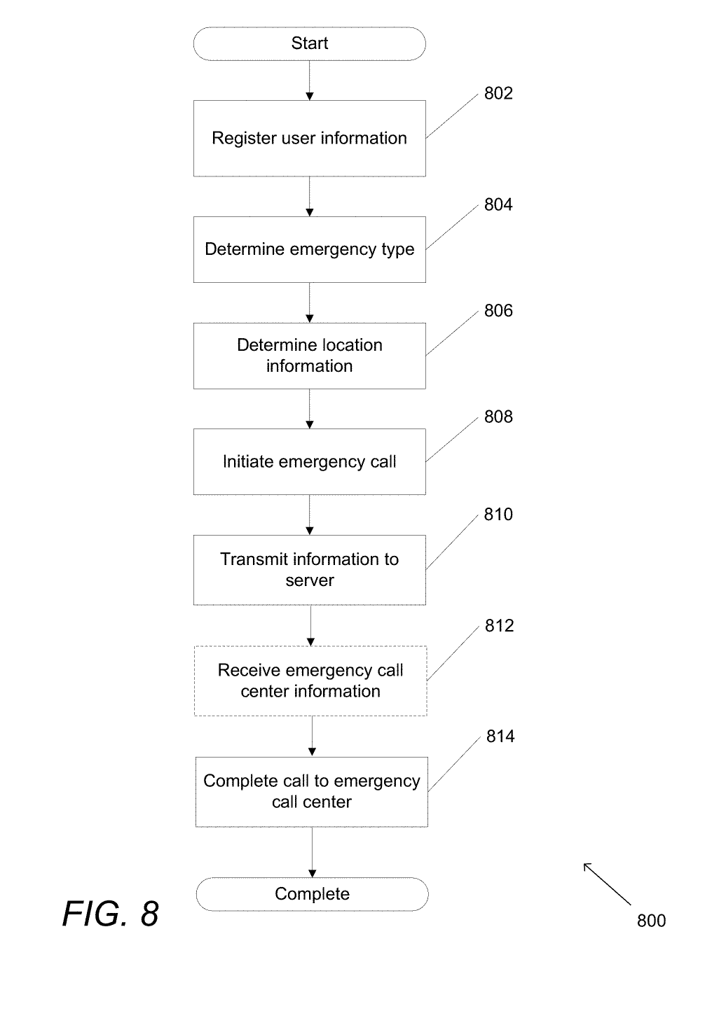

A flow chart illustrating a process for making an emergency phone call using a mobile device in accordance with an embodiment of the invention is shown in FIG. 8. As described above, a user may contact a 911 call center using a variety of methods. For example, the user may call by dialing 911, the user may click a button, or the user may touch a selection on a screen on a mobile device to initiate contact with the call center. The process 800 may be executed by a processor of a mobile device using an emergency telecommunications application stored on non-volatile memory of the mobile device, as described above. The process 800 may register (802) user information (e.g. user data) via an interface, as described above. Such user data may include (but is not limited to) name, address, phone number, email address, emergency contact name, emergency contact phone number, and/or emergency contact address. The process 800 may (804) determine an emergency type (e.g. emergency data) via an interface, as described above. Emergency types may include (but are not limited to) fires, medical emergencies, robberies, car accidents, drunk drivers, firearm discharges, and/or general emergency assistance. The process 800 may gather and/or determine (806) location information (e.g. location data), as described above. Some embodiments may utilize GPS modules where available on mobile devices. Other embodiments may utilize triangulation techniques or data from local networks to determine location information. Location information may be coded in geocode, GPS coordinates, and/or latitude and longitude coordinates.

The process 800 may also initiate (808) an emergency call. While operations 802, 804, and 806 are shown above initiating (808) an emergency call, these operations may be performed after, before, and/or during initiating (808) of the emergency call. For instance, registration of user information (802) may be performed during a time of relative safety, whereas determining an emergency type and determining location information may be performed near a time of initiating an emergency call.

The process 800 may transmit (810) information such as (but not limited to) user data, location data, emergency data to an emergency telecommunications server, as described above. The information gathered by operations 802, 804, and 806 may be transmitted at varying times relative to initiation of the emergency call. For example, user data may be transmitted well before an emergency and stored for later use, whereas location data may be transmitted shortly after initiation of the emergency call. In some embodiments, the process 800 may receive (812) emergency call center information. The received emergency call center information may be selected based on the transmitted data. For instance, the received emergency call center information may indicate the closest and/or most appropriate emergency call center based on the type of emergency, specialization, location, current bandwidth, etc. The process 800 may then complete (814) a call to the identified emergency call center. During the call, the emergency call center operator may access critical information gathered by process 800 using the emergency services telecommunication system, as described above.

Although specific processes for emergency services telecommunication systems using servers and mobile devices are discussed above with respect to FIGS. 7-8, any of a variety of processes and variations of the described processes as appropriate to the requirements of a specific application may be utilized in accordance with embodiments of the invention. Moreover, while processes are presented as in an order herein, alternative orders of operations may be utilized without departure from the spirit of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A method for providing emergency services using an emergency telecommunications server having a processor and a network interface in network communication with a mobile device associated with a user and at least one emergency call center, the method comprising:
receiving user data, at the emergency telecommunications server, from the mobile device, using the network interface;
receiving location data, at the emergency telecommunications server, from the mobile device, using the network interface;
determining, a first call center from the at least one call center to provide emergency services to the user associated with the mobile device; and
transmitting, by the emergency telecommunications server, to the first call center, the user data and the location data using the network interface.

2. The method of claim 1, further comprising:
receiving emergency data, at the emergency telecommunications server, from the mobile device, using the network interface; and
transmitting, by the emergency telecommunications server, to the first call center, the emergency data using the network interface.

3. The method of claim 1, wherein the user data includes a user name.

4. The method of claim 1, wherein the user data includes a date of birth.

5. The method of claim 1, wherein the user data includes a call back number.

6. The method of claim 1, wherein the user data includes medical history data.

7. The method of claim 1, wherein the user data includes drug allergies data.

8. The method of claim 1, wherein the user data includes health data captured using the mobile device.

9. The method of claim 2, wherein the emergency data includes an emergency type provided by the user using the mobile device.

10. The method of claim 2, wherein the emergency data includes image data captured using a camera of the mobile device.

11. The method of claim 1, wherein the location data includes a longitude coordinate and a latitude coordinate of the mobile device.

12. The method of claim 11, wherein the longitude and latitude coordinates are derived using global positioning system (GPS) data.

13. The method of claim 11, wherein the longitude and latitude coordinates are derived using Wi-Fi data.

14. The method of claim 11, wherein the longitude and latitude coordinates are derived using IP Address data.

15. The method of claim 11, wherein the longitude and latitude coordinates are derived using cell tower triangulation data.

16. The method of claim 11, wherein the longitude and latitude coordinates are derived using metadata collected by the mobile device.

17. The method of claim 1, further comprising receiving, at the emergency telecommunications server, from the first call center, a request for additional data using the network interface.

18. The method of claim 1, further comprising determining the first call center using the user data.

19. The method of claim 1, further comprising determining the first call center using the location data.

20. The method of claim 2, further comprising determining the first call center using the emergency data.
